(19) United States
(12) Patent Application Publication
(10) Pub. No.: US 2011/0144820 A1
(43) Pub. Date: Jun. 16, 2011

(54) WIRELESS PROGRAMMABLE CONTROL SYSTEM

(75) Inventor: Ricardo Trauer, Curitiba (BR)

(73) Assignee: ILUFLEX-COMERCIO DE EQUIPAMENTOS ELETRONICOS LTDA-EPP

(21) Appl. No.: 13/057,907

(22) PCT Filed: Aug. 8, 2008
(86) PCT No.: PCT/IB08/53196

§ 371 Date: Feb. 7, 2011

(51) Int. Cl. G06F 1/26; G08C 19/12

(52) U.S. Cl. 700/295; 341/176

(57) ABSTRACT

A wireless programmable control system applied in home automation that aims at solving the problems of the state of the art such as lack of simplicity and a straight forward way to program and set up a system with several wireless devices working together and the fact that either a programming device must be used to set up the system, or the system is too simple and doesn't allow any programming at all, or it uses a bidirectional communication means. In order to solve the problems mentioned the system of this invention is composed basically of two components: a transmitter unit and a receiver control unit. The transmitter unit is basically a wireless device that transmits a unique code each time a switch is pressed. The unique code associated to each switch is in binary format and is broadcast using a wireless signal. The unique code is factory programmed in the transmitter unit avoiding any additional programming by the user, therefore simplifying the installation process.

### TECHNICAL FIELD

This invention relates to a wireless programmable control system, and more specifically to a method and programming sequence applied in home automation, using a wireless control for remotely controlling the amount of power delivered to an electrical device connected to a receiver control unit.

### BACKGROUND ART

With the advance of microelectronics, systems for controlling a device with a wireless remote controller have gained many applications with the addition of functions and robustness of the systems. Several developments have addressed the need to make the remotely controlled system more user-friendly. It is very common to use infra-red remote controllers and more recently radio frequency in many household appliances and in many industrial applications, as the cost of wireless devices is decreasing.

For home automation systems, many attempts have been made to develop a system that is user-friendly, easy to install, with increased functionalities, capable of being programmed and with the option of being controlled by a wireless remote controller. A good example is the X10 protocol used in wired installations in home or industrial applications of lighting control. This has been broadly expanded to many applications including motors, sensors and programmable controllers, all integrating a network.

A similar concept is used with a wireless network and many new standards were created like Zigbee, Bluetooth and more recently Z-Wave. These standards have in common a bidirectional communication. It is known that there are many advantages associated, mainly that in a network, limitless addressable devices can broadcast messages to a specific device, sharing a common communication medium, making it possible to effectively control an electronic device from any distance.

One example of a networked lighting system is revealed by U.S. Pat. No. 7,161,556 that describes systems and methods for programming illumination devices in which a user interface is coupled to a programming device that is adapted to provide one or more selected addresses to a programmable lighting system, based on user input via the user interface. The system is also adapted to store the one or more selected addresses in memory and uses a network communication link between the system elements.

A different approach to remotely control an electronic device is to use a one-way communication method. This is common in standalone equipments like electronic household appliances that use an infra-red remote controller. Alternatively, radio frequency can be used where the remote controller and controlled device are not in a visible range. In this case, the transmitter is a remote controller and the receiver is located in the device being controlled.

For standalone systems, there is no need for programming the transmitter or receiver as in a TV, for example. However, when more devices are arranged to work together like in a lighting system, a programming issue arises making it necessary to configure how transmitters and receivers should work together.

For example, the U.S. Pat. No. 4,355,309 describes a radio frequency controlled light system that includes a transmitting unit having a receiver unit address and an output address switch for pulse modulating a digitally coded transmission signal. A remotely located receiving unit is capable of controlling the power supplied to an electrical device in response to the received transmission signal.

The U.S. Pat. No. 5,352,957 describes an appliance control system with programmable receivers for a plurality of appliances in distributed arrangement, having a command generator, a receiver associated with each appliance, a control line which connects the command generator to each receiver and a memory in each receiver where an operational address for the associated appliance can be stored.

U.S. Pat. Nos. 6,300,727 and 6,169,377 describe a remotely controllable and programmable power control unit for controlling and programming the state and power level, including special functions, of one or more electrical devices including electric lamps. The system includes a remote transmitter unit and power control unit adapted to receive control signals from the remote transmitter unit. Both the remote transmitter unit and the power control unit include a power selection actuator for selecting a desired power level between a minimum power level and a maximum power level, and control switches for generating control signals representative of programmed power levels of one or more power scenes and special functions. In response to an input from a user, either directly or remotely, the one or more devices of the one or more power scenes can be controlled between an ON or OFF state to a desired programmed preset power level, or to a maximum power level.

In another document, U.S. Pat. No. 6,174,073, it is described a radio frequency remote-controllable lighting system having a plurality of lighting units with an associated switch unit which can respond to a radio frequency signal to connect the element to or disconnect the element from a source of electrical energy, and one or more remote control switch units which are operable to transmit control signals to control operation of the lighting units, the or each remote control switch unit being arranged to transmit radio frequency signals which include an identification portion for identifying those lighting units which are to respond to the transmitted signals.

The US No. 2003210167 describes a wireless remote-control light adjuster comprising a remote-control module and a light adjustment device connected to at least one light bulb. A key module for keying in internal codes of the light adjustment device and used as remote-control keys is disposed in the remote-control module so that the remote-control module can learn each internal code and simultaneously generate several remote-control digital codes used to control the light adjustment device which outputs different degrees of electricity to the light bulb according to the remote-control digital code received.

A similar example is described by U.S. Pat. No. 6,759,966 where a wireless remote-controlled lighting system is composed of a remote controller module and a remote control receiver installed in each of at least one addressable light bulb, having an assigned unique address thereto, which is stored in a memory in each bulb. The remote controller module is used to emit a remote control signal to be received by the remote control receiver, the address for which has been entered into the remote controller module by a user.

The U.S. Pat. No. 6,175,201 describes an addressable light dimmer and addressing system that use a DMX protocol controller to selectively generate an electronic address for the addressable lighting device on which the device will respond to all future signals from the controller. The addressable device has a program mode for setting the address and a working mode for receiving control signals on the set address.

A different approach to initially establish a communication link between devices in a network is revealed by the U.S. Pat. No. 7,254,367 that describes a method and apparatus for pairing and configuring wireless devices with each other without affecting other wireless devices in the vicinity, by bringing devices into close proximity, while in a whisper mode communication.

### DISCLOSURE OF INVENTION

### Technical Problem

In the area of home automation and more specifically in lighting systems, a lot of development has been made using a bidirectional communication network between devices with the objective to simplify installation, increase flexibility and to allow a wide integration with all kinds of electronic appliances used in a home or business environment. All these systems have excellent technical characteristics and may represent a new trend in future home installation. However, all these benefits come with the downside of increased complexity and, as a consequence, with a significant cost increase. For this reason, home automation is not widely spread in the worldwide market.

In order for a wireless-controlled home automation system to be readily accepted by users a number of considerations must be addressed. In particular for lighting systems, the system must be capable of unambiguously controlling selected lighting units in the system and of incorporating lighting units which are later added to the system. Furthermore, it is necessary to develop a solution capable to compete with simple and low cost installations, without compromising the benefits that home automation can bring to the user, and thus creating a new market share between high end solutions of home automation systems and the traditional old way to hardwire electrical circuits inside a house.

This can be achieved by reducing the complexity of the system, benefiting from the wireless technology and using a minimum of digital microelectronic components. It is important to keep the wireless solutions as simple as possible, therefore, only a one-way communication is preferred. To associate a remote switch to a wireless control device capable of controlling the amount of power delivered to an electrical device connected to it, a programming issue arises since many devices should work together in a system. Special care must be taken to allow multiple transmitters and receiving units to work in the same area, sharing the same communication medium without interfering with each other.

For example, the lighting system disclosed by U.S. Pat. No. 4,355,309 uses a receiver unit address and an output address switch which is setup by using DIP switches. This introduces several limitations in the system since each receiver or transmitter can have only one address, therefore limiting the number of different devices working together. Furthermore, a person must have access to both transmitter and receiver units, and the limited number of different addresses can make difficult the installation in buildings where a high number of devices is needed.

An appliance control system with programmable receivers is disclosed by U.S. Pat. No. 5,352,957 and reveals a substantial improvement by using a receiver unit with memory to store one operational address. This eliminates the need for DIP switches in the receiver. A similar concept is revealed by U.S. Pat. Nos. 6,300,727 and 6,169,377. However, these disclosures do not address the initial wireless identification of the devices. In both cases, the number of different addresses is limited, therefore the amount of remote controllers operating near each other is supposed to be small.

Another wireless controlled lighting system is disclosed by the U.S. Pat. No. 6,174,073 where the transmission of an address and an instruction is enough to control one or more remote controlled devices. In this case though, it is possible to control several devices with one remote controller switch. Nevertheless, this solution lacks in providing an easy way to program it. An additional programming device must be used to setup the system. For example, if one wants a bit more complex operation like using a remote controller to switch OFF all lights or to use an inverted logic, where switch OFF at the remote controller will switch ON a light, an additional programming device must be used. Therefore, this system lacks in providing an easy way to configure lighting scenarios. Furthermore, if the remote transmitting unit must be programmed, it should have additional means to program it, including memories and input devices which will increase its associated cost when compared to simple remote transmitter switch units.

Another solution is revealed by the U.S. No. US2003210167. To configure the system, the user must program and store in the remote controller memory a digital key that will be sent to the remote light intensity control unit. Although several remote light intensity control units can be controlled by one remote controller when several digital keys are programmed and stored in its internal memory, this system lacks in providing a way to configure lighting scenarios. Another disadvantage of this system is that the remote unit must have a key module for keying in a digital code to be sent to the light intensity control units. The remote control unit also comprises a memory for storing the keyed in digital codes, requiring more components and increased costs.

A more complex system is disclosed by U.S. Pat. No. 6,175,201, which typically uses an addressable receiver and commands to control a lighting device. A powerful but expensive DMX controller is used to send commands to the lighting system. Again, the cost of the system is increased.

A different approach is disclosed by U.S. Pat. No. 6,759,966 where a wireless remote controller can learn the address of a wireless controlled light bulb. This implies in programming the remote controller and controlled device and therefore both sides must have a receiver and a transmitter. Again this increases the cost and complexity of the system.

A System and method for programming illumination devices is disclosed by U.S. Pat. No. 7,161,556 and is based on a programming device that is used to set a select address to a programmable lighting system and thus providing a more flexible integration of the whole system. But all benefits come with a great cost of complexity and higher amount of components and the need of a networked communication. Every time a user interface must include some sort of display, the system is not as simple as a single push button interface.

To simplify the initial configuration of a wireless network an alternative approach is revealed by U.S. Pat. No. 7,254,367. The revealed method though is only applicable in a network with bidirectional communication link.

It is important to notice that in many cases the transmitter unit or remote controller unit transmits an address followed by an instruction set or command to the addressable receiver. This requires more processing power at the transmitter unit where buttons must be associated to a particular command and transmitted together with an address. The receiver must be addressable and must perform according to the command sent, which again adds more complexity to the solution. Furthermore, in such systems, each button in a transmitter is associated to one particular command and sent to only one addressed receiver. When more receivers should be operated, then more buttons or more transmitters must be used, resulting in a system with more components and higher complexity for the user. Alternatively, a desired command can be sent to different receiver units by repeating the command with different associated addresses, which necessarily have been previously programmed in the transmitter unit. If more than one receiver units are programmed with the same address, then they will always act as they were the same, and become equivalent to only one receiver.

Another inconvenience is the need of a programming device to setup such kind of system. In many other solutions, the receiver control unit has a fixed address, like a MAC address, and this address must be programmed in the remote transmitter unit to be sent together with the command or instruction. Again a more complex programming issue arises since the transmitter must be programmed and, in many cases, a bidirectional communication is implemented to reduce the programming effort. In all cases the cost is much higher than conventional wired installations.

In all systems cited above there is a lack of simplicity and a straight forward way to program and set up a system with several wireless devices working together. Either the solution has a small number of different devices that can be controlled or a programming device must be used to set up the system, or the system is too simple and doesn't allow any programming at all, or it becomes more complex and uses a bidirectional communication means. Therefore, it is necessary to develop a wireless control system with reduced cost, easily programmable and with the necessary flexibility to allow some complex tasks available in modern home automation systems.

### Technical Solution

The wireless control system presented by this invention has a simple but effective method for programming and setting up a wireless control system.

One objective of the wireless control system is to be flexible and programmable, allowing some sophisticated tasks of a typical home automation system, like programming lighting scenarios that can be controlled by one or more remote controllers. In a lighting scenario the ON or OFF state of a receiver control unit can be programmed and when the receiver control unit has a power level control circuit, different light intensities can be configured for each lighting scenario.

Another objective of the present invention is to allow different electrical devices to be controlled by the receiver unit, like an electrical light source or a motor or an electrical heater device. There are many other electrical devices that can be controlled by the system presented in this invention, extending its use to a broader home automation system.

Another objective of the present invention is to allow the transmitter to be actuated not only by a switch, but to expand its functionality by adding a sensor, capable of generating a control signal that can be used to trigger programmed events. This can be particular useful when a temperature should be controlled or a presence sensor is desired. Other sensors can generate different control signals that can trigger the transmission of a unique code associated to a sensor signal level.

Another objective of the present invention is to allow the transmitter unit to send a unique code at a programmed time, allowing the receiver control unit to be automatically controlled at a desired time.

Another objective of the present invention is to allow the receiver control unit to be programmed from a small distance by a wireless means, and thus eliminate the need to physically access the program switches. This allows a reduced setup effort of the system, especially when receiver control units are located in places difficult to reach.

In order to solve the problems above mentioned the wireless programmable control system of the present invention is composed basically of two components: a transmitter unit and a receiver control unit. The transmitter unit is basically a wireless device that transmits a unique code each time a switch is pressed. The unique code associated to each switch is in binary format and is broadcast using a wireless signal. The unique code is factory programmed in the transmitter unit avoiding any additional programming by the user, therefore simplifying the installation process.

The receiver control unit is a device that has an electronic control circuit that can control the power supplied to an electrical device connected to it in response to a unique code received. All the logic association of a pressed switch in the remote transmitter unit to a desired action of the receiver control unit is programmed by a simple procedure, therefore eliminating the need of additional programming devices. This is accomplished with two programming switches in the receiver unit. A first program switch is employed to store a unique code used to switch ON or increase the power of an electrical device. A second program switch is employed to store a unique code used to switch OFF or reduce the power to an electrical device. The programming sequence can be repeated as many times as different transmitter switches should be associated to control a receiver control unit.

During normal operation, the activation of a transmitter switch broadcasts its associated unique code. This unique code is received by a receiver control unit and is compared to the one stored in the memory by the program switches. In case the unique code received matches to the one stored in memory with the program switch, the corresponding action is taken according to the program switch used. By letting the receiver control unit be configured only by the program switches, there is no need to send a command after the unique code and, as a consequence, any transmitter switch can control a receiver control unit. Therefore, it is also not necessary to use an additional programming device to setup the system.

There is no limit of how many receiver units can be controlled by one transmitter as long as they are within the transmission range. There is also a high number of transmitter switches unique codes that can be stored in a receiver control unit either by the first or the second program switch. Therefore, the combinations of transmitter and receiver units that can be setup to work together in a wireless control system are almost unlimited.

In the receiver control circuit, the unique codes are stored in a non-volatile memory during programming procedure. This will avoid losing the programmed codes after a power failure. The unique code is big enough to allow millions of different combinations, and thus avoid the coexistence of a same code associated to different remote controller switches in the same place. With this characteristic it is possible to have a high number of different transmitters and receivers being setup to work together, and thus, enable this system to be easily setup in a large building installation.

The programming procedure to store a unique code in the receiver non-volatile memory is simple and intuitive. The first step is to press the program switch in the receiver unit for the desired action, for example to switch ON a light connected to it. The receiver control unit will enter in programming mode and wait for the transmission of a unique code. The second step is to activate the switch of the transmitter unit that should be used to switch ON a light in this example. The receiver control unit will then store the unique code received from the transmitter switch in the non-volatile memory and exit the program mode. Each time the associated transmitter switch is pressed the light will switch ON. To switch OFF the light, the same transmitter switch can be used or any other, having only to be previously programmed with the second program switch in the receiver unit.

The control circuit inside the receiver control unit can have a power level control device that can selectively adjust the power level to an electrical device connected to it. In this case, the first program switch will be used to store a unique code to increase the power output and the second program switch to decrease the power output. Then, when the transmitter switch is pressed and is sending the unique code repeatedly, the receiver control unit will increase or reduce the power until the transmitter switch is released or a maximum or zero power level limits are reached. After a power level remains unchanged for some time, it is stored in non-volatile memory in association with the unique code used to increase it. When the transmitter switch is actuated for a short period, then the receiver control unit will switch ON the power up to a previously stored value if the unique code was stored with the first program switch and will switch OFF the power if the received unique code matches the one stored with the second program switch. This extends the usability in lighting scenarios letting different power levels and light intensities to be configured and easily used in the wireless control system.

A programming transmitter unit with a first and second program switch can be used to remotely control a receiver control unit, where a command is transmitted within a reduced transmission range, acting on the receiver control unit in the same way as the program switches were pressed. This enables the receiver control unit to enter in programming mode without needing to physically accessing it to press the first or second program switch. By significantly reducing the transmission range of the programming transmitter unit, it is possible to have all receiver control units to be controlled by the same command. The selection of which receiver unit is to be programmed is extremely simple, needing only to approximate the programming transmitter unit to the receiver control unit. The short transmission range will avoid that other receiver control units in the vicinity will enter in programming mode at the same time.

The programming technique disclosed in this specification is trouble-free and simple, also extremely flexible and powerful. In lighting control applications the system described in this invention can be used to control different lighting scenarios. The same programming technique can be applied to control motor, heaters and many other electrical appliances when the power control circuit is changed to suit those applications. By adding sensors to control the transmission of unique codes, the same programming technique can be used to extend the functionalities of the system. Therefore the wireless control system herein described will suit many home automation applications and its usability in industrial environment is not limited in any way.

For example, one transmitter unit switch located at the exit door can be used to switch OFF all lights in the house. This is configured by storing its unique code in all receiver units with the said second program switch of each receiver unit. When the switch of the transmitter unit located at the exit door is actuated, all receiver control units will switch OFF the lights connected to them, regardless if they were previously ON or OFF.

Another example is in a living room with an ambient for dining and a home theater system. A handheld transmitter unit switch can be setup to switch ON the lights used when a movie is being watched. The same switch can be used to switch OFF all other lights in the room. Other transmitter switches can be used to switch individual lights. By associating a transmitter switch to a desired ON or OFF state of each ambient lights, different lighting scenarios can be easily configured. Additionally, a projection screens can be controlled by the system and be controlled by the same transmitter switch used in the lighting scenario example. This is implemented with a receiver control unit that has a power control circuit capable of controlling a motor that is connected to the projection screen. So when the transmitter switch for the home theater scenario is actuated, the projection screen is automatically opened. It is further possible to use the transmitter switch for the dining scenario to automatically close the projection screen, for example. All this can be implemented using a handheld remote control transmitter unit or any other for convenience.

For the person skilled in the art it will become easy to extend this programming technique to many similar applications and should be therefore considered to be encompassed by this invention.

### Advantageous Effects

This system represents a major improvement over previous wireless control systems, mainly because of its innovative programming method associated to a reduced cost and a one way communication link.

By choosing a one-way wireless communication link between the transmitter unit and the receiver control unit the system described in the present invention is extremely simplified compared to those systems that implement a bidirectional communication within a network architecture.

Since all programming for associating a unique code from a transmitter switch to control a receiver control unit is performed only by the two programming switches in the receiver control unit, there is no need for additional programming devices that would greatly increase the cost of the system. Especially when lighting scenarios are desired, its configuration is accomplished with a simple programming procedure that eliminates the need of additional programming devices that normally have a user interface with displays, keypads, memories and higher processing power.

Another important innovation brought by the present invention is the concept of controlling the system without any specific instruction set or command following a selected address. By selectively storing a unique code in the receiver control unit and using it to control the receiver unit, the solution is greatly simplified but extremely flexible. The association of a one-way wireless communication link with the simple unique code is the main responsible for a significant cost reduction without compromising the programming benefits that only more complex systems present.

Any transmitter switch can be used to control any receiver control unit and with the advantage that there is no restraint to which switch to use for a desired action. Receiver control units with different power control circuit characteristics can be controlled by the same transmitter unit switch. For example, a receiver control unit that switches ON and OFF and a receiver control unit that has a power level control circuit can be controlled by the same transmitter unit switch. This is particularly interesting for a handheld remote transmitter unit that enables the user to control lights in the house with a single remote controller that has several switches configuring lighting scenarios and controlling different receiver control units. The user can configure each switch in the remote transmitter unit to control one or more receiver units with no restriction to the desired combination and resulting action. For example, a handheld transmitter unit can be used to control lights, window covering, projection screen, garage door, lighting scenarios and many more depending on the receiver control units and its power control circuit chosen.

Furthermore, this innovative concept of configuring transmitter units and receiver units to work together as a system greatly improves the flexibility enabling the combination of different models of transmitters and different models of receiver units to work together, and thus enabling the resulting wireless programmable control system to perform complex tasks in a cost-effective solution. Sensors can be integrated into the system to allow some automated tasks. For example, when someone is entering a corridor the lights can be automatically switched on by using a transmitter unit with a presence sensor.

Another advantage of the present invention is that the transmitter unit has no need for programming simplifying the concept and setup of the system, and thus enabling reduced installation time and the reduction of associated costs. Since only a unique code is transmitted, there is no need to select addresses or to configure them, as it is necessary in other commercial solutions.

With the transmitter architecture not having to constantly monitor a switch position, the transmitter has ultra low power consumption in standby mode since almost no current is drained from the battery when the transmitter switch is not actuated. This is especially important for a long battery life.

In many cases the receiver control unit will be installed in places difficult to reach, for example in the ceiling behind an illumination device, resulting in a difficult actuation of the program switches. In some cases components must be disassembled to access the receiver unit, resulting in a time consuming procedure. For such cases, the programming transmitter unit is extremely helpful and reduces the effort needed to configure the system. Furthermore, it reduces the installation time and associated costs.

By choosing a radio frequency that is distant from other widely used frequencies for other consumer products such as IEEE 802.11 2.4 GHz or 900 Mhz, a reduced interference from such kind of products is obtained. This highly improves the robustness of the wireless communication link between transmitter and receiver units since less interference will be generated by other household appliances in the used transmission frequency.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn with all connections between the components and that are merely intended to conceptually illustrate the structures and procedures described herein.

### DESCRIPTION OF DRAWINGS

The accompanying drawings are examples of some embodiments of this invention and are to be understood as illustrative of the invention and not as limiting in any way. The drawings are not intended to be drawn on scale, and each identical or nearly identical component that is illustrated in various figures is represented by a like numeral. For purposes of clarity, not every component may be labeled in every drawing.

FIG. 1 illustrates a transmitter unit.

FIG. 2 illustrates a receiver control unit.

FIG. 3 illustrates a program routine to store a transmitter switch unique code into said non-volatile memory of the receiver control device.

### MODE FOR INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of ‘including’, ‘comprising’, or ‘having’, ‘containing’, ‘involving’, and variations thereof herein, is meant to encompass the items listed thereafter and equivalents thereof as well as additional items.

According to the present invention, the wireless programmable control system comprises at least one transmitter unit for emitting a unique code associated to each transmitter switch and one or more receiver control units that receive the transmitted code signal from said transmitter units, further having a control circuit for controlling the power delivered to at least one electrical device in response to a unique code signal received.

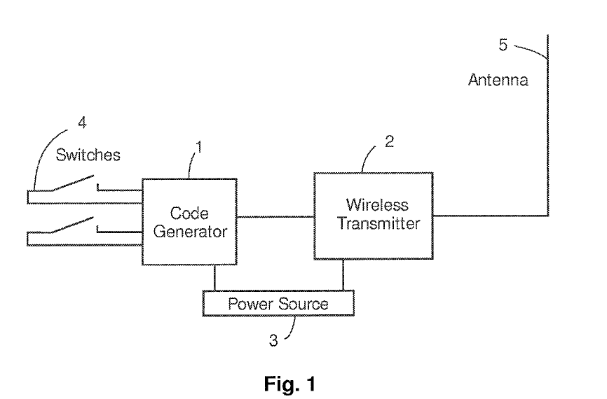

The transmitter unit is illustrated in FIG. 1 and comprises at least one transmitter switch (4), having a unique code associated to it. When a switch (4) is actuated in the transmitter unit, a unique binary code is generated by the code generator (1). The code generator (1) converts the unique binary code associated to the transmitter switch (4) into a pulse sequence that is modulated by the wireless transmitter (2), generating a radio frequency signal that is sent to an antenna (5) and broadcast to all receiver control units within the transmission range. Although the wireless transmission of the unique code by the transmitter unit can be in the infra-red spectrum when an infra red LED and associated driving circuit is used instead of an wireless transmitter (2) and the antenna (5), the transmission in the radio frequency spectrum is preferred to allow the transmitter unit and receiver control unit to be installed outside a visible range from each other. There are many ways to modulate and broadcast a binary signal and they are considered to be known by the person skilled in the art. There are many commercially available wireless modules that suit this application.

The transmitter switch (4) can be a push button or a tactile switch or a keypad or any other type of switch or any other means of user input device. In case the transmitter has several switches, the code generator (1) generates a different binary code for each switch (4). Several switches in the same transmitter unit have different unique codes associated which again are different from switches in other transmitter units. This is accomplished by having a unique binary code programmed into the code generator (1) for each switch (4), which normally is factory programmed and has no need to be changed. The transmitted unique code signal is in binary format and is long enough to allow millions of different combinations. The binary code length is typically comprised between 16 bits and 40 bits. A high number of combinations assure an extremely low probability that two identical codes are transmitted from different transmitter units in the same installation or in a transmission range from each other. Therefore, a unique binary code is associated to each switch (4) in a transmitter unit and is equivalent to a transmitter switch address used to unambiguously identify each transmitter switch.

The transmitter unit sends the unique code when the switch (4) is actuated and repeats the transmission as long as the switch (4) remains actuated. This is particularly necessary for the programming sequence of the unique code in the receiver unit that needs several repetitions of the same code to confirm it. It is also useful when the receiver control unit has a dimmer (power leveling) function. In this case, the receiver control unit increases or reduces the power of a light source as long as the associated unique code is being received.

The transmitter unit also comprises a power source (3). The power source (3) can be a replaceable battery with a long life, say 3 to 10 years. Alternatively, the battery can be a rechargeable type and be recharged by an external power supply for convenience. Alternatively, the power source (3) can be a solar cell or a piezoelectric transducer or an electromagnetic transducer or any kind of ambient energy harvesting device to allow unlimited operation time and the absence of servicing the battery. In all cases though, the transmitter unit components utilize low power consumption features that enable longer battery life. When necessary, the transmitter unit can have a external power supply that replaces a battery. Preferably, the transmitter unit is a wireless device for easy installation and use.

Each transmitter unit is a self contained unit and can be portable like a handheld device or can be fixed to a wall or any other surface when a fixed location is desired. When fixed to a wall, a transmitter unit looks like a normal wall mounted light switch and therefore replaces a traditional wired installation with a wireless link. When the transmitter unit is a handheld device it can have a similar appearance to a remote controller for controlling an electric garage door or a TV set for example. For controlling a lighting system the transmitter unit can also be designed as a portable unit that can be placed in a bracket fixed to a wall. This is particularly interesting to enable the transmitter unit to be carried by the user and later be stored back in its original location.

In all cases, the transmitter unit controls a remotely located receiver control unit and thereby controls an electrical device connected to it. When the said electrical device is an electric light, then a wireless lighting control system is configured with the advantage that no wires are required between the control switch and the lighting unit.

The transmitter unit is not limited in one code generator (1) since more than one code generator can be used in case the transmitter unit should have a high number of switches (4). Another arrangement of the transmitter unit is to have the wireless transmitter (2) and the code generator (1) integrated into one single chip device, and they were described here as separate devices for illustration purpose only. The code generator (1) can be a commercially available microelectronic device or an encoder or it can be programmed into a microcontroller. In case a bigger number of transmitter switches (4) is used a microcontroller is preferred. Another example where a microcontroller can replace a code generator (1) is when the transmitter unit comprises sensors or a programmable clock. Another possibility not shown in FIG. 1 is to have an auxiliary display in the transmitter unit if programmable parameters must be set, like temperature limits or timed events. In all cases though, the resulting action is to generate a unique code when a switch is pressed or when another event triggers the transmission of a unique code.

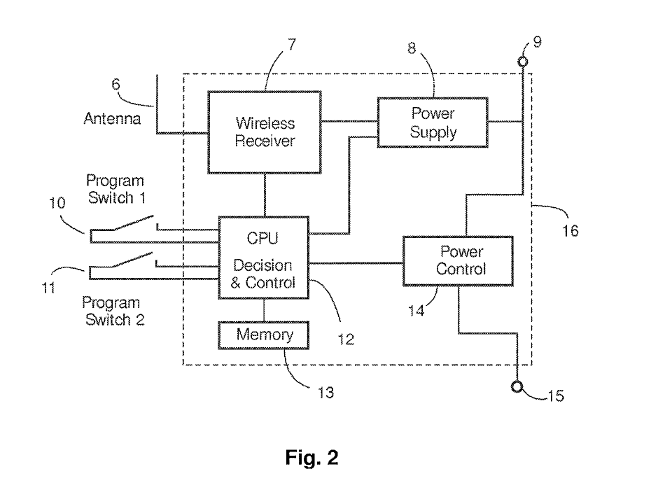

The receiver control unit is illustrated in FIG. 2 and comprises a control circuit (16) composed by an antenna (6) that receives the wireless signal, an wireless receiver (7) that transforms the wireless signal into a digital output, a central processing unit (12) that is programmed for decoding and decision, a non-volatile memory (13) to store the programmed unique codes, a power control circuit (14) for controlling the electric power delivered to a said electrical device and a power supply (8) which provides DC power to all components of the control circuit. The receiver control unit comprises at least two program switches (10) and (11), which are used to program the unique code of the transmitter switch (4) used to remotely control de receiver control unit. The two program switches (10) and (11) can be part of the control circuit (16) or can be externally located and connected to the control circuit (16).

The central processing unit (12) is normally a microprocessor or a microcontroller for cost-effective multi I/O control applications with built in program memory, data memory, counters and other built in devices for minimum periphery component architecture. When a wireless signal with a unique code is received by the wireless receiver (7) it is decoded by the central processing unit (12). It is then compared to the ones stored in the non-volatile memory (13) with the first (10) or second (11) program switches. In case there is a match, the central processing unit (12) acts on the power control circuit (14) accordingly. For example, when the unique code received matches the one stored with the first program switch (10), the power control circuit (14) is controlled to switch ON or increase the power to the said electrical device connected to it. In case the unique code matches the one stored with the second program switch (11) the action is the opposite, reducing or switching OFF the power to the said electrical device connected to the power control circuit (14).

The function of the receiver control unit can vary according to the power control circuit (14) used. In one embodiment of this invention, the power control circuit (14) is an electrically controlled switch that connects the mains entrance (9) through the output (15) to an electrical device. In this case, the unique codes stored with the first (10) or second (11) program switches are used to switch ON or OFF an electrical device.

In another embodiment of this invention the power control circuit (14) comprises a power level control circuit capable of adjusting the power level delivered to said electrical device connected to it. It is most likely that the electrical device is a light source and, in this case, the receiver control unit is able to adjust the brightness of a lamp. For controlling the receiver control unit, the first (10) and second (11) program switches are used to store unique codes that when received increase or reduce stepwise the power of a light source. The power control circuit (14) can adjust the electric power to the electrical device connected to it from a zero power level up to a maximum power level. It is most likely that the power level control circuit comprises a TRIAC for controlling the power using a Pulse Width Modulation technique. To synchronize the microcontroller with the alternate current from the mains a zero-crossing detection circuit can be used. A power level control circuit is considered to be known by a person skilled in the art to which many references can be found in the literature.

In another mode of this invention when the power control circuit (14) comprises a power level control circuit, a desired power level can be stored in the non-volatile memory (13) and can be associated to each unique code stored with the first program switch (10). This feature is particularly interesting to allow lighting scenarios to be configured. The receiver control unit can distinguish when a transmitter switch (4) with its associated unique code previously stored in the receiver control unit is transmitted during a short period of time or during a longer period of time, for example, more than 0.5 seconds. When the transmitter switch (4) is actuated for a short period of time and its associated unique code is stored with the first program switch (10), then the power control circuit (14) switches ON the power level up to a previously stored value associated with the received unique code. When the transmitter switch is actuated for a short period of time and its associated unique code is stored with the second program switch (11), then the power control circuit (14) switches OFF the power to an electrical device connected to it. This feature enables the receiver control circuit to be programmed to deliver different power levels for each different unique code stored. When the transmitter switch is actuated for a long period of time, then the power level control circuit increases or reduces stepwise the power delivered to an electrical device resulting in a fading effect of the brightness of the light. When a desired power level is obtained and is not changed for some time, the actual power level is stored in a non-volatile memory associated with the unique code of a transmitter switch stored with the first program switch (10). This enables the user to change a previously stored power level during normal operation, without the need to physically access the receiver control unit.

In all cases though, the receiver control unit is controlled remotely by the transmitter switches (4) associated with each program switch (10) or (11) and therefore no instruction set or command is needed to control the receiver control unit. Additionally, the receiver control unit can have an auxiliary LED that indicates the status of the receiver unit. This is particularly interesting to indicate that the receiver is in programming mode, or that a unique code has been correctly received.

To improve the robustness of the system, the receiver control unit can recognize and validate a unique code only when two or more repetitions of the same unique code are received consecutively. This avoids interference or corrupted data to cause a failure in the control system. Since the transmission of a unique code is completed within a few milliseconds, the transmission of several unique codes normally occur even when the transmitter switch is actuated for a short period of time by the user.

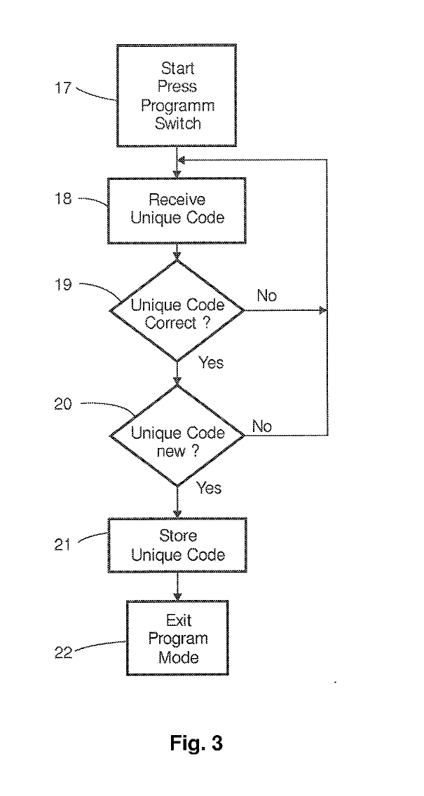

The program sequence to store a unique code in the non-volatile memory (13) can be best understood by the FIG. 3. When the program switch (10) or (11) of the receiver control unit is actuated, the programming sequence for storing a unique code is started (17). The receiver control unit then waits for a unique code to be received (18). The received unique code is checked for integrity and if the correct number of bits has been received (19). If the unique code is correct, it is further compared (20) to the ones already stored in the non-volatile memory (13). In case the received unique code is a new code, it is stored in the non-volatile memory area corresponding to the program switch used (21). To guarantee that the unique code is correct (19), the receiver control unit waits for more than one transmission of the same unique code, considering it correct only after several codes received are compared to each other and are all the same. This is important to avoid an incorrect unique code to be stored or any interference during the reception of the unique code to corrupt the data. Therefore, the transmitter switch (4) that should be programmed in the receiver control unit should be actuated during a longer period of time than in a normal operation to allow the receiver control unit to receive several times the same unique code. When this sequence is finished the receiver control unit exits the programming mode (22) and is ready to be controlled by the transmitter switch (4) used.

The same programming sequence applies for the first (10) and second (11) program switches. The difference is that when the programming sequence is activated by the first program switch (10), the unique code is stored in a memory location reserved only for unique codes stored with the first program switch (10). When the programming sequence is activated by the second program switch (11), the unique codes are stored only in a memory location reserved for unique codes associated with the second program switch (11).

By selectively storing the unique codes within the non-volatile memory (13), according to the program switch used, it becomes easy to compare the received code to the ones previously stored and obtain the desired action. During normal operation of the receiver control unit, when a unique code received is compared to the ones previously stored and it matches the one stored in a non-volatile memory location reserved for the first program switch (10), it is then easy to confirm the desired action. The same happens when the received code matches one stored in the non-volatile memory location reserved for the second program switch (11).

In case the receiver control unit is comprised by a power control circuit with an electric switch, then the same unique code can be stored by the first (10) and second (11) program switches, allowing the same transmitter switch (4) to be used to switch ON or OFF the said electrical device connected to it.

By repeating the programming sequence, different transmitter switches (4) are associated to a receiver control unit to control it. Each receiver control unit can be controlled by one or several transmitter switches and one transmitter switch can control one or several receiver control units, having almost no limit for both extremes. When the non-volatile memory (13) has reached its limit in storing unique codes and the programming switch is actuated, then the newest unique code received can replace the oldest unique code stored, overwriting it. It is also possible to erase the non-volatile memory. This can be achieved by actuating the program switch (10) or (11) for a long period of time, like 3 or more seconds. This is particularly necessary when a wrong unique code has been stored and the programming sequence should be repeated with a correct transmitter switch.

The wireless receiver (7), the central processing unit (12) and the non-volatile memory (13) can be separate devices or they can be integrated into one single chip device. They are here considered separate devices for illustration purposes only and any combination thereof should be considered to be included in the scope of the present invention. It is very common in the art for central processing units to have a non-volatile memory built in. The non-volatile memory (13) can be an EEPROM type or FLASH type or any other type that can keep the stored data even when no power is supplied.

Another embodiment of this invention is a transmitter unit comprised with an integrated sensor device replacing the transmitter switch with a sensor signal level. In this case a unique code is transmitted each time a preset or adjusted sensor signal level is reached. An example of this embodiment is a presence sensor used to switch ON a light when someone is inside a room controlled by the presence sensor. In this example, the presence sensor sends a unique code when someone is near it and sends a different unique code when no one is near it. With these two unique codes, one or more receiver control units can be controlled by the presence sensor with a wireless link.

Another example is when the receiver control unit is controlling an electric heating device and the transmitter sensor is a thermoelectric sensor. In this example, the transmitter can be configured to send a unique code to switch ON the heating device when the temperature riches a minimum preset level and switch OFF when the temperature rises until a maximum level.

Another example in lighting application is to use a sensor to automatically switch on a light during the night. The transmitter unit with a photoelectric sensor can be adjusted for a preset value at which a unique code is sent and used to switch OFF a light controlled by a receiver control unit. The same transmitter can send another unique code to switch ON the light when it is dark, for example. Since a wireless link is used between transmitter and receiver units and the power source of the transmitter unit can be a battery, there is a great freedom in choosing an appropriate location to install the transmitter.

Since the receiver control unit can be programmed to respond to a unique code but has no feedback signal, it is better to repeat the transmission of the unique code associated to a preset sensor level during some time to guarantee that the receiver will have received the unique code and act accordingly. The repetition time would typically allow from 5 up to 15 repetitions of the same unique code.

More than one sensor signal level can be programmed and each programmed sensor signal level can have a selected unique code associated to it. This will enable different actions or events to be configured and controlled by the transmitter with a built in sensor.

To assist in programming and setting up the transmitter unit with an integrated sensor device, additional configuring switches or an auxiliary keypad can be used. It is most likely that such a transmitter unit has a display that indicates the sensor level and possible associated unique codes used to control a receiver control unit, and thus implementing an appropriate and optimized user interface, necessary to carry on all programming tasks required for this transmitter unit.

Another embodiment of this invention is a transmitter unit with an integrated timer, capable of being programmed to send a unique code at a selected time. In this case, the transmitter unit comprises a display and control switches used to set the clock and to program timed events that triggers the transmission of a unique code. Several timed events can be programmed, each of them having a selected unique code associated. Each timed event is not limited to transmit only one unique code and there is also no restriction to use only one unique code for different events or to have a different unique code for each different timed event programmed. This allows the receiver control unit to be controlled in many different ways by the transmitter unit with an integrated timer. This can be useful for example to automatically switch ON a light at a selected time and switch OFF at another time. Another example is when the receiver control unit is controlling an electric valve connected to it and this valve controls an irrigation pipeline for a garden. This enables the automatic start of the irrigation of the garden at a programmed time. Since the programming of unique codes is the same, and other transmitter units can be used, in this example, the garden irrigation can be manually started with another transmitter, with its associated unique codes stored in the receiver control unit.

Another embodiment of this invention is a receiver control unit with a power control circuit for controlling a motor and the electrical device connected to it being an electric motor. In this case, the programming switches can be used to store unique codes that control the motor motion. For example, the first program switch (10) is used to store unique codes that, when received, switch ON the motor in one direction. The second program switch (11) is used to store the unique code that, when received, switch ON the motor in the opposite direction. In this example the motor keeps its movement as long as the unique code is constantly being received, that is, as long as the associated transmitter switch (4) is being actuated. When the transmitter switch (4) is released and the unique code is not transmitted anymore, then the motor stops its movement. This is a typical application for controlling Rolling Shutters or interior window coverings. In this case an additional limit switch can be used to prevent motor movement outside a limiting range and thus preventing the motor from overrunning or causing any damage to the system. Another example is when the additional limit switches are used to stop the motor movement. In this case, the transmission of a unique code will start the motor movement in a direction defined by the associated program switch. The motor will keep its movement until the additional limit switch is reached. This can be useful, for instance, in controlling a projection screen that should be kept only open or closed. It is important to notice that in this case, the same transmitter unit can be used to control a motor or a light or any other electrical device, since all programming of the receiver control unit is performed with the program switches that will store a unique code, not requiring any additional commands or instructions to be sent by the transmitter unit even if the function of the power control circuit is different.

To extend the transmission range of a transmitter unit a wireless signal repeater unit can be used. In this case, the unique code received by the repeater unit is checked for integrity prior to its retransmission. The retransmission only is started after the transmission of the transmitter unit has stopped. This is important to avoid that the repeater interferes with the transmitter unit, overlapping both transmissions which results in a mixed and unrecognizable wireless signal by receiver control units. Since the repeater unit can be powered by an AC power supply, a wide range transmitter with a higher transmission power compared to the ones used with the transmitter units can be used. This will overcome any difficulties if a receiver control unit is located beyond the transmission range of a transmitter unit. Alternatively, the repeater can be a standalone unit with the same wireless transmitter used in the transmitter units and be likely powered by batteries or any other ambient energy harvesting device.

Another embodiment of the present invention is a receiver control unit capable of receiving a wireless command to enter in programming mode and act as the programming switches were pressed. There are two different wireless commands, one for instructing the receiver control unit to enter in programming mode to store a unique code like the first program switch and a second command for instructing the receiver control unit to enter in programming mode and act as the second program switch were pressed. All receiver control units will accept the same command and no additional address is necessary or any other configuration. This feature enables to program the receiver control unit wirelessly, without the need to physically access it for pressing the program switches used to configure the system. This is very useful when the receiver control unit is installed in places difficult to access or when the user wants to reconfigure the wireless control system, eliminating the need to disassemble components that are blocking the access to the receiver control unit. Therefore, this feature reduces the effort and time consumed in configuring the wireless control system presented by this invention.

A programming transmitter unit that comprises a first and second program switch is used to transmit a wireless command to a receiver control unit. The wireless command is in binary format and is modulated and broadcast in the same way as is the unique code. It can also have the same number of bits or can have different number of bits than the unique code. Preferably, the wireless command has the same number of bits than the unique code, allowing the same decoding routine already programmed in the central processing unit (12) to receive and recognize the wireless command received.

A code generator can be used in the programming transmitter unit to generate the wireless command when the first or second transmitter programming switches are actuated. The difference from the code generator (1) used in the transmitter unit is that the wireless command is always the same for all programming transmitter units and therefore the programmed code in the code generator is not changed, as it is for a normal transmitter unit.

Since all receiver control units accept the same command and therefore behave the same way, it is necessary to be able to select which receiver control unit is to be programmed. This is accomplished by using a programming transmission mode with a significantly reduced transmission range, where the transmitted command is received only within a short distance, like 1 meter for example. A programming transmitter capable to operate in this programming transmission mode must be approximated to the receiver control unit that is to be programmed. Since the transmission range is very small, only the closest receiver control unit that is within the small transmission range receives the transmitted command, without affecting other receiver control units in the vicinity.

The programming transmitter unit for transmitting a program command can be a dedicated transmitter that operates only with the programming transmission mode. In this case, it has only two transmitter program switches. The first transmitter program switch, when actuated, transmits a first command to instruct the receiver control unit to act as the first program switch (10) in the receiver control unit was actuated. The second transmitter program switch, when actuated, transmits a second command to instruct the receiver control unit to act as the second program switch (11) was pressed. This programming transmitter unit is typically used to aid the configuration steps of the wireless control system by avoiding to physically accessing the receiver control unit. Since the programming wireless transmitter unit must be used in a small distance from the receiver control unit, it is preferably constructed like a handheld remote controller.

The programming transmitter unit can also be integrated into a previously described transmitter unit, whereby the first and second transmitter program switches are distinguished from the other normal transmitter switches. In this case, the transmitter unit must be capable to operate in two different transmission modes, one for normal operation, when a transmission of a unique code is desired and one for the programming transmission mode used only when the programming switches are actuated.

The reduced transmission capability characteristic of the programming transmission mode can be implemented in many different ways, and the exemplary methods described herein are solely for the purpose of illustration and are not intended to limit the scope of this invention. One intuitive example to implement a programming transmission mode is to have two separated wireless transmitter circuits, one used to transmit unique codes in a normal transmission range and a second wireless transmitter circuit with a significantly reduced transmission power for transmitting a command only within a short transmission range. The second wireless transmitter can be implemented by an appropriate reduction in power to wireless transmitter circuit, wherein transmission amplifiers are suitably programmed for reduced amplification limiting its output power and consequently its transmission range. In another example, the reduced transmission range may be achieved by dispensing or bypassing the transmitter antenna and thus limiting the efficiency of the transmission circuit and consequently limiting its transmission range. Another example is taking advantage that the transmission signal is modulated in only one fixed central frequency having a small Gaussian shaped bandwidth for improved transmission efficiency, in both transmitter and receiver wireless circuits. By using a transmitter with a slightly different transmission frequency, like in a neighbor wireless channel that only partially overlaps the original transmission signal, a significant reduction in the range of communication is achieved. The wireless transmitter circuit can be programmed to selectively transmit in two central frequencies that only partially overlap each other. A normal mode of operation is achieved when the usual transmission frequency is used and the programming transmission mode is achieved when the second transmission frequency is used resulting in a reduced transmission range. Any previously described alternative and others for reducing the transmission range can be implemented separately or can be combined to implement the programming transmission mode with reduced communication range.

In the best mode of this invention the transmission frequency chosen is preferably one distant from other widely used radio frequencies in household appliances like 2.4 GHz or 900 MHz. Since the transmission of a unique code requires a low transmission power associated to a transmission period of few milliseconds then many other frequencies in the UHF and VHF spectrum can be chosen, mainly those comprehended between 300 and 500 MHz.

Furthermore, the signal between the transmitter unit and the receiver control unit can be an amplitude-modulated, frequency-modulated, phase-modulated, pulse width-modulated or digitally code generated signal. It should be apparent to the person skilled in the art that although the implementation hereinbefore described employs a one way wireless radio frequency communication link between the transmitter and the receiver, that link can be replaced by an infrared, microwave or ultrasonic link as well. For some special applications, where a security issue exists, the unique code can be encrypted prior to transmission. In this case, the receiver will need to have a decryption routine programmed in the central processing unit to enable a correct recognition of the encrypted unique code received.

While the invention has been disclosed by the detailed description above, the accompanying drawings and examples, various equivalents, modifications and improvements will be apparent to the person skilled in the art. Such equivalents, modifications and improvements are intended to be encompassed by the following claims.

1. A wireless programmable control system for remotely controlling electrical power delivered to at least one electrical device characterized by comprising:
(a) at least one transmitter unit having at least one switch, a wireless transmitter and a code generator, wherein the code generator generates a unique code signal in response to actuation of a switch, said unique code signal being transmitted by the wireless transmitter, and wherein said unique code signal is always the same for said switch and is different from other codes associated to other switches or other transmitter units in the system; and
(b) at least one receiver control unit that receives the transmitted unique code signal from said transmitter unit, having a first and second program switch associated with a control circuit comprised by a wireless receiver, a central processing unit, a non-volatile memory and a power control circuit for controlling the power delivered to at least one electrical device in response to a unique code signal received, wherein
said control circuit is programmable with the first program switch that stores in the non-volatile memory a unique code received from said transmitter unit in response to actuation of said first program switch and subsequent transmission of said unique code to be stored, and
said control circuit is programmable with the second program switch that stores in the non-volatile memory a unique code received from said transmitter unit in response to actuation of said second program switch and subsequent transmission of said unique code to be stored.

2. A system according to claim 1, wherein said power control circuit controls the power level to said at least one electrical device.

3. A system according to claim 2, wherein said at least one electrical device comprises a lighting source and said power control circuit for controlling the power level delivered to said at least one electrical device comprises a light intensity control circuit for controlling the light intensity of said lighting source, enabling the wireless programmable control system to be configured as a lighting control system.

4. A system according to claim 2, wherein the power level can be stored in the non-volatile memory and in case a unique code is received and matches the one stored in the non-volatile memory with the first program switch, the power control circuit switches ON the power up to a previously stored power level associated to the unique code received.

5. A system according to claim 2, wherein the power level can be stored in the non-volatile memory and in case a unique code is received and matches the one stored in the non-volatile memory with the first program switch, the power control circuit changes the power to a previously stored power level associated to the unique code received.

6. A system according to claim 2, wherein the unique code received by a receiver control unit is compared to the code previously stored in the non-volatile memory with the said second program switch and in case the codes are equal, the power control circuit will switch OFF the power supplied to said at least one electrical device.

7. A system according to claim 2, wherein the unique code received by a receiver control unit is compared to the code previously stored in the non-volatile memory with the said first program switch and in case the codes are equal and is continuously being received, the power control circuit increases in stepwise the power supplied to said at least one electrical device.

8. A system according to claim 2, wherein the unique code received by a receiver control unit is compared to the code previously stored in the non-volatile memory with the said second program switch and in case the codes are equal and is continuously being received, the power control circuit decreases in stepwise the power supplied to said at least one electrical device.

9. A system according to claim 1, wherein said power control circuit for controlling the power delivered to said at least one electrical device comprises an electrical switch that switches ON or OFF the power delivered to said at least one electrical device.

10. A system according to claim 9, wherein the unique code received by a receiver control unit is compared to the code previously stored in the non-volatile memory with the said first program switch and in case the codes are equal, the power control circuit switches ON the power supplied to said at least one electrical device.

11. A system according to claim 9, wherein the unique code received by a receiver control unit is compared to the code previously stored in the non-volatile memory with the said second program switch and in case the codes are equal, the power control circuit switches OFF the power supplied to said at least one electrical device.

12. A system according to claim 9, wherein the unique code stored in the non-volatile memory by said first and second program switches can be equal, and in this case, the control circuit will switch from ON to OFF or from OFF to ON when the unique code signal received from the transmitter unit is equal to the one stored in the non-volatile memory.

13. A system according to claim 9, wherein said at least one electrical device comprises a lighting source and said power control circuit for controlling the power delivered to said at least one electrical device, comprises a light control circuit for switching the light ON or OFF.

14. A system according to claim 1, wherein said at least one electrical device comprises an electrical motor and said power control circuit for controlling the power delivered to said at least one electrical device comprises a motor motion control circuit for controlling the motion of the motor in response to said unique code received and compared to the unique code stored in the non-volatile memory by said first program switch or second program switch.

15. A system according to claim 14, wherein the motor motion is adapted for actuating a limiting switch, generating a control signal for stopping the movement of the motor.

16. A system according to claim 1, wherein the transmitter unit comprises a sensor device for generating a control signal used to transmit a unique code when the sensor control signal reaches a predefined level, the predefined sensor control signal level being programmable.

17. A system according to claim 16, wherein the transmitter unit comprises at least one additional configuration switch used to program the sensor control signal level at which the transmission of a unique code is triggered.

18. A system according to claim 16, wherein the transmitter unit is configurable to transmit different unique codes for different sensor control signal levels.

19. A system according to claim 16, wherein the transmitter unit with a sensor device comprises a temperature sensor and one or more different temperature levels can be programmed to transmit a unique code when the programmed temperature is reached, wherein the unique codes transmitted can be different.

20. A system according to claim 16, wherein the transmitter unit with a sensor device comprises a presence sensor.

21. A system according to claim 1, wherein the transmitter unit further comprises a configurable clock circuit for sending one or more unique codes at one or more programmable timed events.

22. A system according to claim 1, wherein the receiver control unit stores more than one unique code in the non-volatile memory when the programming sequence activated by the program switches is repeated.

23. A system according to claim 1, wherein the receiver control unit erases the unique code stored in the non-volatile memory when the program switch is activated for a long period of time, enabling the control circuit to be reprogrammed.

24. A system according to claim 1, wherein the receiver control unit can receive a first wireless command to enter in programming mode and act as if the said first program switch were actuated, and can receive a second wireless command to enter in programming mode and act as if the said second program switch were actuated.

25. A system according to claim 24, wherein the transmitter unit comprises a first programming switch for generating and transmitting said first wireless command, a second programming switch for generating and transmitting said second wireless command, wherein the wireless transmitter is modified to operate with a significantly reduced transmission range to transmit the said first or second wireless command when the first or second program switch is actuated.
